(19) United States
(12) Patent Application Publication
(10) Pub. No.: US 2003/0094095 A1
(43) Pub. Date: May 22, 2003

(54) Fluid-operated cylinder-piston unit

(75) Inventor: Giacomo Orioli, Guastalla (IT)

Correspondence Address: BROWDY AND NEIMARK, P.L.L.C., 624 NINTH STREET, NW, SUITE 300, WASHINGTON, DC, 20001-5303, US

(73) Assignee: CONDUCTOR TECHNOLOGY LTD., London (GB)

(21) Appl. No.: 09/988,331

(22) Filed: Nov. 19, 2001

(51) Int. Cl. F15B 11/08

(52) U.S. Cl. 91/454

(57) ABSTRACT

The cylinder-piston unit comprises a headpiece, within the body (25) of which there are provided: a pressurized fluid inlet (23) to be connected to the feed; a fluid outlet (24); at least one conduit (21) communicating with the first operating chamber; between the inlet (23) and the conduit (21), a first passage (A) having in a lateral face of the body (25) two spaced-apart ports (31a, 32a), one communicating with the inlet (23) and the other with the conduit (21); and finally, between the outlet (24) and the conduit (21), a second passage (B) having in a lateral face of the body (25) two spaced-apart ports (31b, 32b), one communicating with the outlet (24) and the other with the conduit (21). In each of said passages (A, B) there is provided a valve for opening or closing the fluid passage, comprising a lateral chamber (35) covering said communication ports (31, 32) and formed in a cover (27d, 27s) positioned on the lateral face of the body of the headpiece, and a free flexible membrane (36) separating said ports (31, 32) from the lateral chamber (35) and being arranged to assume a first position in said ports (31, 32) are closed and a second position in which they are open; thin pilot channels (51, 52) are provided to feed into the lateral chamber (35) a pilot fluid to urge the membrane (36) into the first position for closing the ports (31, 32), against the thrust of the fluid present in the ports; a pilot valve means (40) is also provided communicating with the fluid feed, to distribute, when commanded, pressurized pilot fluid to the lateral chambers (35) via said pilot channels (51, 52), to open the first passage (A) and close the second (B) and vice versa.

This invention relates to a fluid-operated cylinder-piston unit having at least a first operating chamber for alternate connection to a pressurized fluid feed and to a discharge. A typical but not exclusive application is to a cylinder-piston unit also having a second operating chamber opposing the first (double-acting).

As is well known, to operate fluid-operated cylinder-piston units a circuit has to be provided connecting its operating chambers to a fluid feed and discharge and to a distributor valve which, on command, connects one chamber to the feed while simultaneously connecting the other chamber to discharge, and vice versa, depending on how the cylinder-piston unit is required to operate.

All this requires not only plant elements and distributor valves of possibly high cost, but also considerable personnel times for making said connections and installing the plant. Moreover, if the cylinder-piston unit is some distance from the distributor valve, long connection pipes are required, making the plant complicated.

An object of this invention is to provide a cylinder-piston unit which overcomes said drawbacks.

This and further objects are attained by the invention as characterised in the claims.

The invention is characterised by comprising:

a pressurized fluid inlet to be connected to the feed, and provided within the body of the headpiece to which the cylindrical wall laterally bounding the operating chamber is connected;

a fluid outlet provided within the body of the headpiece;

at least a first conduit provided within the body of the headpiece and communicating with an operating chamber of the cylinder-piston unit;

within the body of the headpiece, between the inlet and the conduit, a first passage having in a lateral face of the body of the headpiece two spaced-apart ports, one communicating with the inlet and the other with the conduit;

within the body of the headpiece, between the outlet and the conduit, a second passage having in a lateral face of the body of the headpiece two spaced-apart ports, one communicating with the outlet and the other with the conduit;

in each of said passages there being provided, covering said communication ports, a lateral chamber formed in a cover positioned on the lateral face of the body of the headpiece, and a free flexible membrane separating said ports from the lateral chamber and being of such an area as to cover said communication ports, it being arranged to assume a first position in which it adheres to the edge of the ports and a second position in which it is raised from the edge of the ports;

thin pilot channels provided partly within the body of the headpiece and partly in the cover, to feed into the lateral chamber a pilot fluid having a pressure such as to urge the membrane into the first position and to press on it with a thrust sufficient to prevent passage of fluid through the ports, against the thrust of the fluid present in the ports;

a pilot valve means communicating with the fluid feed to distribute, when commanded, pressurized pilot fluid to the lateral chambers via said pilot channels, to open the first passage and close the second and vice versa.

The invention is described in detail hereinafter with the aid of the accompanying figures which illustrate by way of non-exclusive example one embodiment thereof relative to a double-acting cylinder-piston unit.

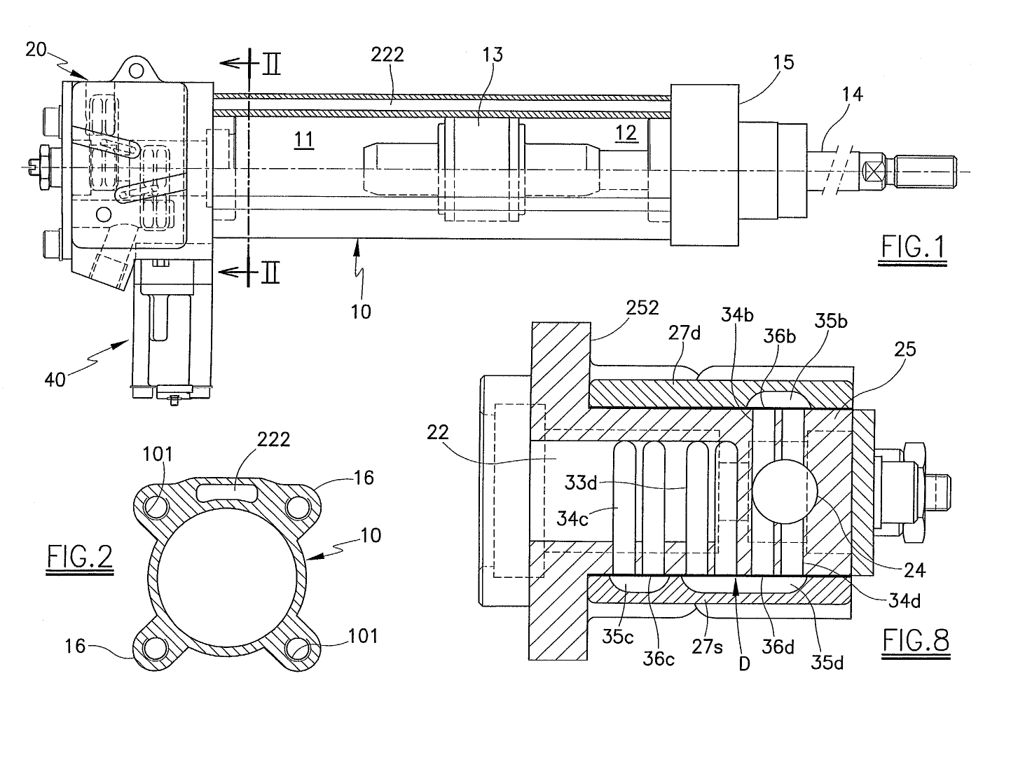

FIG. 1 is a side view of the entire cylinder-piston unit.

FIG. 2 is a section on the plane II-II of FIG. 1.

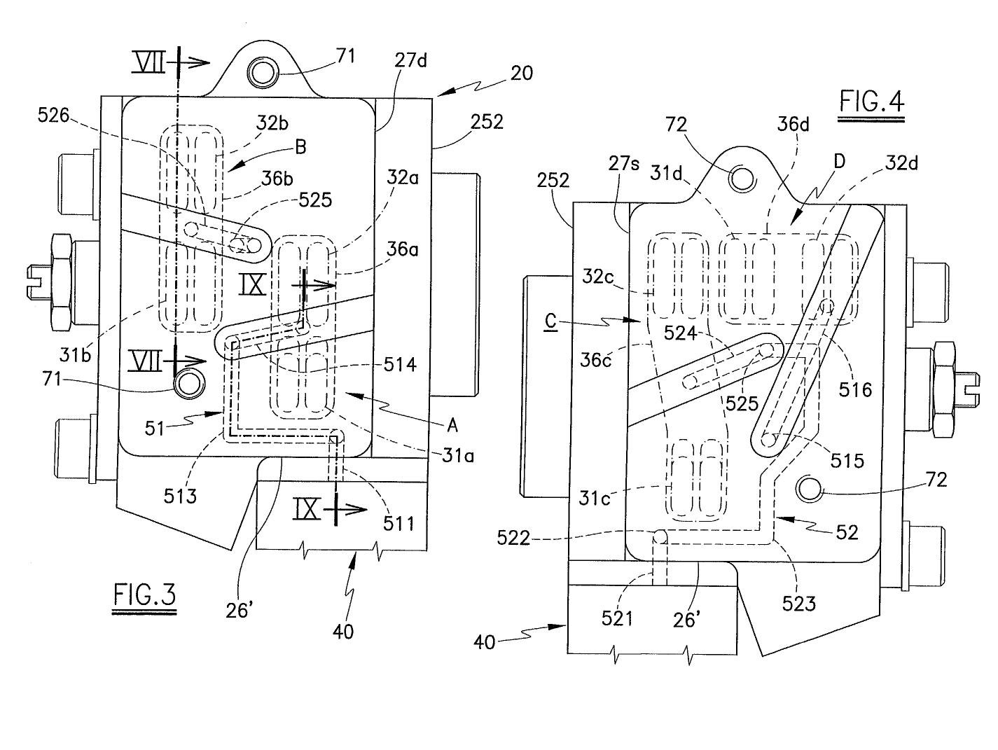

FIG. 3 is an enlarged detail of FIG. 1 relating to the headpiece.

FIG. 3A shows the detail of FIG. 3 but without the cover which covers the visible lateral face.

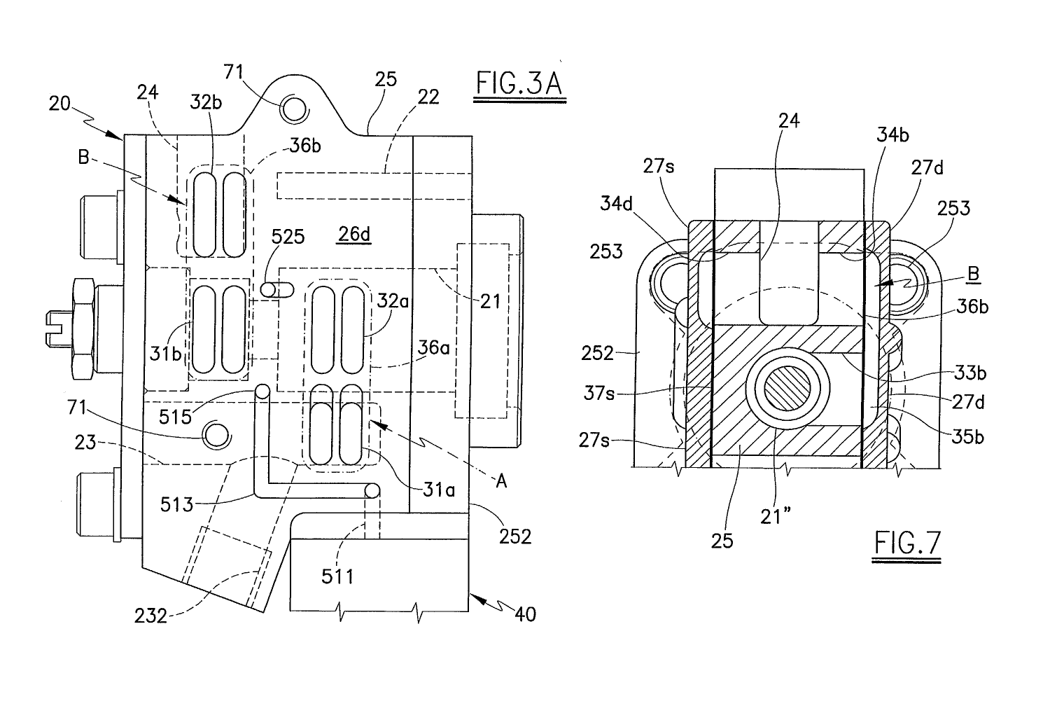

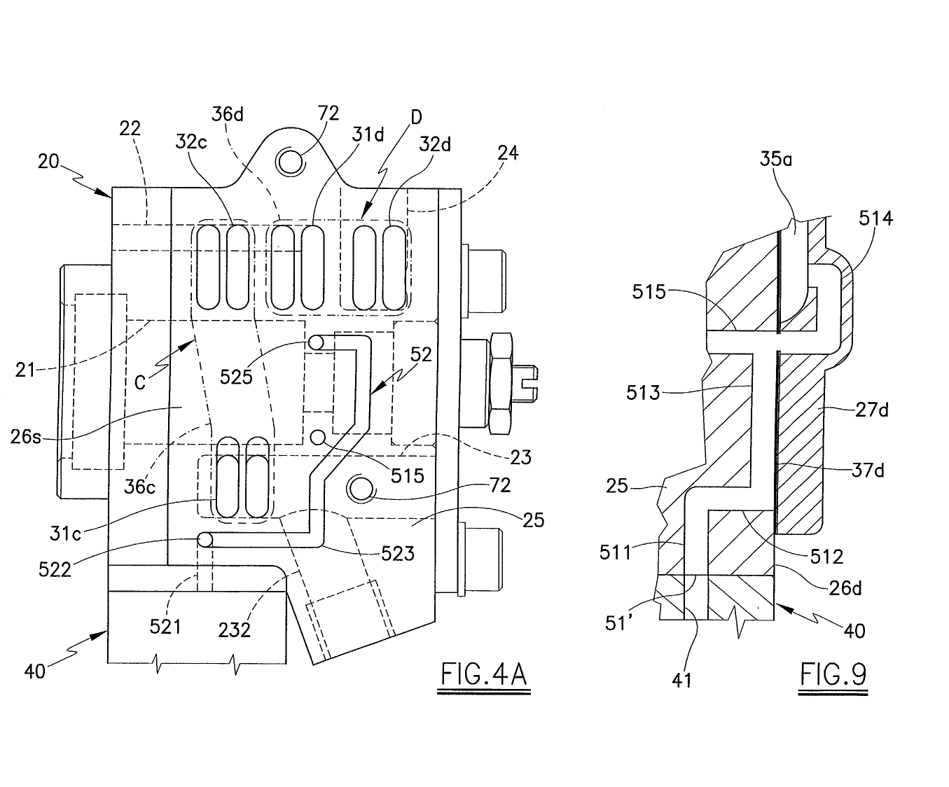

FIG. 4 is a view of the other lateral face of the headpiece.

FIG. 5 shows the detail of FIG. 4 but without the cover which covers the visible lateral face.

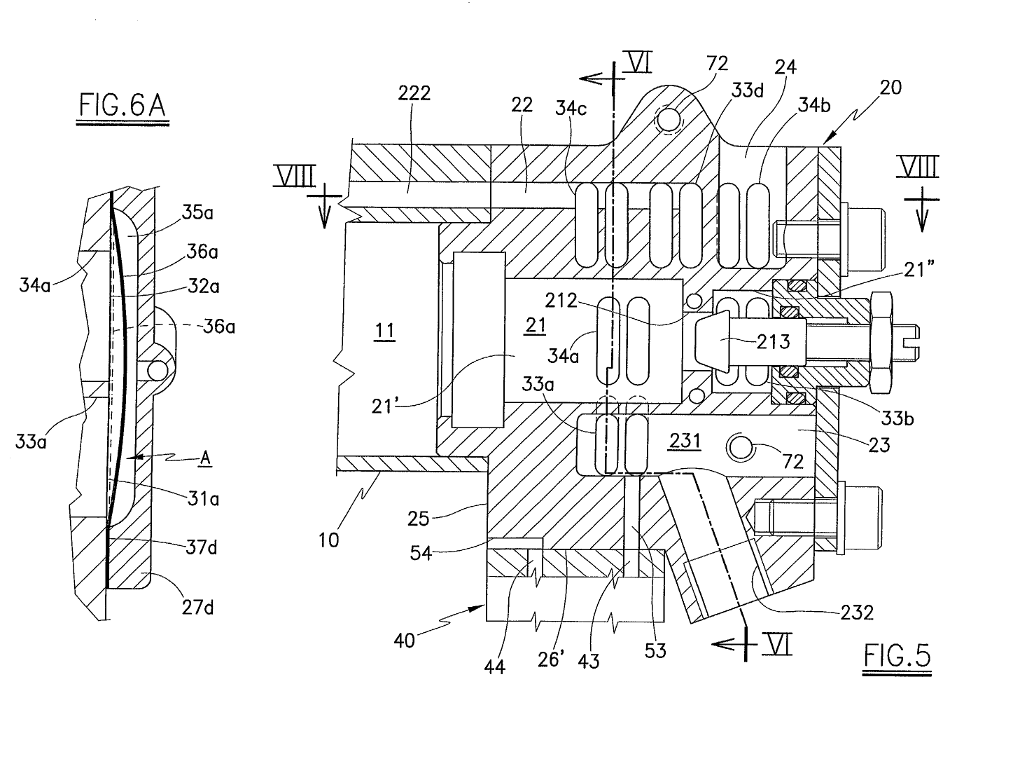

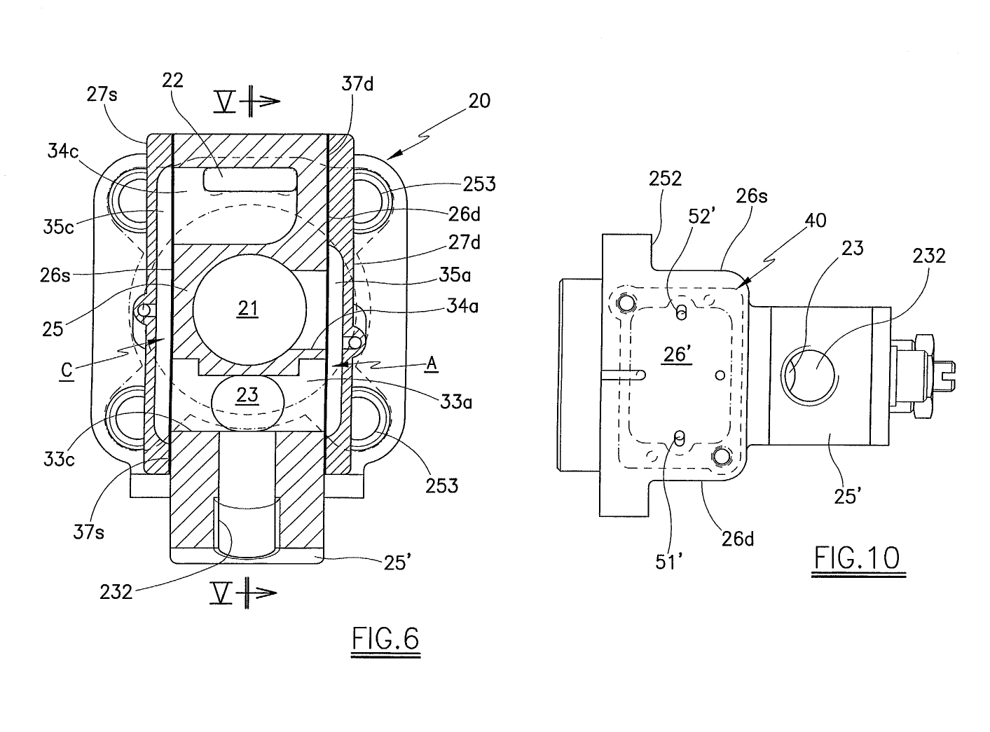

FIG. 5 is a section on the central vertical plane V-V of FIG. 6.

FIG. 6b is a section on the plane VI-VI of FIG. 5.

FIG. 6A is an enlarged detail of FIG. 6.

FIG. 7 is a section on the plane VII-VII of FIG. 3.

FIG. 8 is a section on the plane VIII-VIII of FIG. 5.

FIG. 9 is a partial section on the series of planes IX-IX of FIG. 3.

FIG. 10 is a plan view from below of the headpiece shown without the pilot valve 40.

The cylinder-piston unit shown in the figures comprises a cylindrical wall 10 and a piston 13 slidable in sealed contact with the inner surface of the wall 10, to move an axial rod 14. The two ends of the wall 10 are closed, at the rear by a headpiece 20 and at the front by a front closure element (endpiece) 15, through which the rod 14 sealedly passes. The cylindrical wall 10 laterally bounds two opposing operating chambers 11 and 12, separated from each other by the piston 13. When one of these chambers expands the other contracts with the piston moving in a certain direction, and vice versa.

The cylindrical wall 10 is joined to the headpiece 10 and to the endpiece 15 by screws inserted in the direction of the axis of the cylinder-piston unit through holes 253 provided through the headpiece 20 and through holes (not shown) provided through the endpiece 15. These screws engage corresponding threaded holes 101 provided at both ends of the wall 10, in longitudinal protuberances 16 integral with the wall 10 and projecting radially from it.

The headpiece 20 comprises a body 25, of substantially parallelepiped shape in the figures, having a projection extending about it to define a square-perimeter flange 252 through which said holes 253 are formed.

Within the body 25 of the headpiece there are provided:

a pressurized fluid inlet 23, to be connected to the feed of the operating fluid for the cylinder-piston unit;

an outlet 24 for connecting the fluid to discharge;

a first conduit 21 communicating with the first operating chamber 11 of the cylinder-piston unit, and a second conduit 22 communicating with the second operating chamber 12 of the cylinder-piston unit.

The first conduit 21 and the second conduit 22 consist of dead holes which open into the front face of the headpiece body 25, they being positioned with their axes longitudinal and mutually superposed, and lying in the longitudinal vertical plane of symmetry. The inlet 23 comprises a cavity 231 of longitudinal axis, closed at both ends and positioned below said conduits 21 and 22. The cavity 231 lies with its axis in the vertical plane of symmetry, and communicates with the outside via an inclined lower conduit 232 which opens into the lower face 25′ of the body 25.

In one side of the body 25, namely the right side, there is provided a first passage A between the inlet 23 and the first conduit 21 provided in the body 25. This passage A has two spaced-apart ports 31a and 32a situated in the same right side face 26d of the body 25. The port 31a communicates with the inlet 23 via a short horizontal transverse channel 33a, the other port 32a communicating with the first conduit 21 via a short horizontal transverse channel 34a.

In the embodiment shown in the figures, each of said short channels 33a and 34a (and the analogous channels 33b, 33c, 33d, 34b, 34c, 34d described below) is composed of a pair of short channels, with their cross-section in the form of an elongate thin slot, separated by a thin wall. Likewise, each of the ports 31a and 32a (and the analogous ports 31b, 31c, 31d, 32b, 32c, 32d described below) is composed of two elongate narrow ports separated by a thin strip. For greater ease of description, each said pair of channels 33, 34 and ports 31, 32 is indicated herein as a single channel or single port.

In the same side of the headpiece body 25, ie in its right side, there is also provided a second passage B between the outlet 24 and the first conduit 21 provided within the body 25. This passage B has two spaced-apart ports 31b and 32b situated in the same right side face 26d of the body 25. The port 31b communicates with the first conduit 21 via a short horizontal transverse channel 33b, the other port 32b communicating with the outlet 24 via a short horizontal transverse channel 34b.

In the other side of the headpiece body 25, ie in its left side, there is provided a third passage C between the inlet 23 and the second conduit 22 provided within the body 25. This passage C has two spaced-apart ports 31c and 32c situated in the same left side face 26s of the body 25. The port 31c communicates with the inlet 23 via a short horizontal transverse channel 33c, the other port 32c communicating with the second conduit 22 via a short horizontal transverse channel 34c.

In the same left side of the headpiece body 25, there is also provided a fourth passage D between the outlet 24 and the second conduit 22 provided within the body 25. This passage D has two spaced-apart ports 31d and 32d situated in the same left side face 26s of the body 25. The port 31d communicates with the second conduit 22 via a short horizontal transverse channel 33d, the other port 32d communicating with the outlet 24 via a short horizontal transverse channel 34d.

In each of said passages A, B, C, D there is provided a respective lateral chamber 35a, 35b, 35c, 35d (hereinafter indicated generically by 35) which covers the communication ports 31a, 31b, 31c, 31d and 32a, 32b, 32c, 32d (hereinafter indicated generically by 31 and 32 respectively).

The lateral chamber 35 is provided in a cover positioned on the lateral face of the headpiece body. Specifically, the chamber 35a of the first passage A and the chamber 35b of the second passage B are defined by respective recesses provided in the flat inner surface of one and the same cover 27d, which is adheringly fixed to the right face 26d of the body 25 to cover virtually the whole of this face. Likewise, the chamber 35c of the third passage C and the chamber 35d of the fourth passage D are defined by respective recesses provided in the flat inner surface of another cover 27s, which is adheringly fixed to the left face 26s to cover virtually the whole of this face.

In each of the passages A, B, C, D there is provided a fluid passage opening and closure valve, comprising a free flexible membrane 36a, 36b, 36c, 36d respectively, which separates the ports 31 and 32 of the lateral chamber 35. The membrane 36 has an area such as to cover said ports 31 and 32, and is arranged to assume a first position in which it lies adhering to the edge of the ports and a second position in which it is raised from the edge of the ports.

The membrane 36a of the first passage A and the membrane 36b of the second passage B are formed from a single thin, flexible, deformable sheet 37d, which is pressed by the cover 27d against the face 26d, and has an area equal to that of the cover. The sheet 37d is free to flex and deform in correspondence with the lateral chambers 35a and 35b, to define the respective membrane 36.

Likewise, the membrane 36c of the third passage C and the membrane 36d of the fourth passage D are formed from a single thin, flexible, deformable sheet 37s, which is pressed by the cover 27s against the face 26s, and has an area equal to that of the cover 27s. The sheet 37s is free to flex and deform in correspondence with the lateral chambers 35c and 35d, to define the respective membrane 36.

In detail, the two covers 27d and 27s are fixed to the body 25 by screws (not shown in the figures) which pass through holes 71 and 72 provided in the covers 27d and 27s and in the headpiece body 25 respectively.

FIG. 6A shows by way of example one of the passages A, B, C, D (specifically the first passage A). The two ports 31 and 32 (specifically 31a and 32a) lie in one and the same plane represented by the lateral face 26d, in this plane there lying the membrane 36 (36a) which covers the ports 31 and 32, separating them from the lateral chamber 35 (35a). By way of thin pilot channels (described in detail hereinafter) provided partly within the headpiece body and partly within the cover, a pilot fluid can be fed into the lateral chamber 35 at a pressure able to urge the membrane 36 into its first position, ie adhering to the edge of the ports 31 and/or 32 (as shown by dashed and dotted lines in FIG. 6A and with full lines in FIGS. 6-9), in order to close these ports and hence prevent passage between the ports. The pilot fluid pressure must be such as to press on the membrane 36 with a force sufficient to prevent the force of the fluid present in the short channels 33 and 34, and hence in the ports 31 and 32, being able to separate the membrane 36 from the ports, ie sufficient to prevent passage through these ports. In the embodiment shown in the figures, part of the feed fluid, withdrawn from the inlet 23, is used as the pilot fluid (as described hereinafter). This fluid, fed without relevant pressure drop, into the lateral chamber 35 has a pressure which is amply sufficient to maintain the membrane in its first position even against the feed pressure present in the inlet 23. In contrast, on putting the chamber 35 to discharge, the membrane 36 does not offer substantial resistance to fluid passage and lifts from the ports 31 and 32 (as shown by the full line in FIG. 6A) to allow fluid to pass freely from one port 31 to the other port 32.

Consequently by means of the described shape of the ports 31 and 32, the presence of the membrane 36 and the presence of the lateral chamber 35, there is formed in correspondence with each passage 30 a valve piloted by a pilot fluid withdrawn from the feed to the cylinder-piston unit, to open or close the passage for the operating fluid of the cylinder-piston unit on command.

The pilot fluid is distributed to the passages A, B, C, D by a pilot valve 40 positioned on the inner face 26′ of the body 25. The valve 40 communicates with the fluid feed, in particular the inlet 23, and is arranged to distribute the pilot fluid to the lateral chambers 35 via the pilot channels on command.

The valve 40 is an electrically operated distributor valve. It can be a valve of known type or of the type illustrated in Italian Patent Application No. RE99A000032 filed on 18 Mar. 1999 by the present applicant.

In the embodiment shown in the figures, the cylindrical wall 10 comprises a longitudinally extending channel 222 provided within the thickness of the wall (see FIG. 2) and connected at one end to the second conduit 22, its other end opening into the second operating chamber 12 of the cylinder-piston unit.

In contrast the first conduit 21 communicates directly with the first operating chamber 11 of the cylinder-piston unit. The conduit 21 possesses a front axial portion 21′ communicating directly with the operating chamber 11 and a second axial portion 21″ to the rear of the first, which communicates with the first via an axial passage hole 212, on which there acts a conical piece 213 coaxial to the hole 212 and positioned at a short (but adjustable) distance therefrom. The conical piece 213 defines together with the hole 212 a valve which reduces the pressure of the fluid in passing from the first portion 21′ to the second portion 21″. The channel 34a of the first passage A opens into the front portion 21′, the channel 33d of the fourth passage D opening into the rear portion 21″.

Within the body 25 and covers 27s and 27d there is provided a system of thin channels through which the pilot fluid flows and which open into two ports 51′ and 52′ located in the lower face 26′ of the body 25, for connection to the valve 40, they being aligned in a transverse direction.

From the first port 51′ there extends a duct 51 which, by avoiding the various cavities provided within the body 25, leads both to the lateral chamber 35a of the first passage A, and to the lateral chamber 35d of the fourth passage D. From the second port 52′ there extends a duct 52 which, by avoiding the various cavities provided within the body 25, leads both to the lateral chamber 35b of the second passage B, and to the lateral chamber 35c of the third passage C.

In detail, the duct 51 comprises (see FIG. 9 in particular):

a first channel 511 extending from the port 51′ and penetrating vertically into the body 25,

followed by a second channel 512 which opens in a horizontal transverse direction into the right face 26d,

followed by a third channel 513 extending at a right angle and provided in the face 26d as an open channel, it being closed frontwards by the cover 27d,

followed by a fourth channel 514 which is provided within the thickness of the cover 27d and, after traversing an appropriate hole provided in the sheet 37d, flanks the lateral chamber 35a to then open into the centre thereof.

The duct 51 also comprises:

a fifth channel 515 extending from the upper end of the channel 513 and passing through the body 25 from one side to the other in a transverse horizontal direction, to open in the opposite lateral face 26s of the body 25,

followed by a sixth channel 516 which (in a manner similar to said fourth channel 514) is provided within the thickness of the cover 27s, passes through an appropriate hole provided in the sheet 37s, flanks the lateral chamber 35d and finally opens into the centre thereof.

In detail, the second duct 52 comprises:

a first channel 521 extending from the port 52′ and penetrating vertically into the body 25,

followed by a second channel 522 which opens in a horizontal transverse direction into the left face 26s,

followed by a third channel 523 provided in the face 26s as an open channel and closed frontwards by the cover 27s, its path extending upwards towards the right,

followed by a fourth channel 524 which is provided within the thickness of the cover 27s and, after traversing an appropriate hole provided in the sheet 37s, flanks the lateral chamber 35c of the third passage C to then open into the centre thereof.

The duct 52 also comprises:

a fifth channel 525 extending from the upper end of the channel 523 and passing through the body 25 from one side to the other in a transverse horizontal direction, to open in the opposite lateral face 26d of the body 25,

followed by a sixth channel 526 which in a manner similar to said fourth channel 514 is provided within the thiclness of the cover 27d, passes through an appropriate hole provided in the sheet 37d, flanks the lateral chamber 35b of the second passage B and finally opens into the centre thereof.

The pilot valve 40 comprises a port 41 and a port 42 positioned in correspondence respectively with the port 51′ and with the port 52′ provided in the lower face 26′ of the body 25. The valve 40 also comprises an inlet 43 which communicates with the inlet 23 via a channel 53 provided within the body 25 from its lower face 26′. Finally, the valve 40 comprises an outlet 44 which discharges to atmosphere via a channel 54 provided in the lower face 26′ of the body 25.

On electrically operating the valve 40, this assumes two configurations.

In a first configuration, the first pilot duct 51 is connected to the discharge outlet 44, whereas the second duct 52 is connected to the inlet 23.

Consequently, the lateral chamber 35a of the first passage A and the lateral chamber 35d of the fourth passage D are put to discharge, the respective membranes 36 consequently allowing free passage of the operating fluid. Simultaneously, the lateral chamber 35b of the second passage B and the lateral chamber 35c of the third passage C are put under pressure, the respective membranes 36 consequently being pressed against the respective ports 31 and 32 to close passage for the operating fluid.

Hence the operating fluid passes from the inlet 23 to the first conduit 21 and from there to the first operating chamber 11 of the cylinder-piston unit. Simultaneously, the fluid present in the second operating chamber 12 of the cylinder-piston unit is connected to discharge 24 via the second conduit 22.

In the second configuration of the valve 40, the first pilot duct 51 is connected to the inlet 23, whereas the second duct 52 is connected to the discharge outlet 44.

Consequently, the lateral chamber 35a of the first passage A and the lateral chamber 35d of the fourth passage D are put under pressure, the respective membranes 36 consequently being pressed against the respective ports 31 and 32 to close the passage for the operating fluid. Simultaneously, the lateral chamber 35b of the second passage B and the lateral chamber 35c of the third passage C are put to discharge with the result that the respective membranes 36 leave the passage for the operating fluid free.

It follows that the operating fluid passes from the inlet 23 to the second conduit 22 via the third passage C, and from there to the second operating chamber 12 of the cylinder-piston unit. Simultaneously, the fluid present in the first operating chamber 11 of the cylinder-piston unit is connected via the first conduit 21 to discharge 24 via the second passage B.

Hence by operating the valve 40 the required operation of the cylinder-piston unit is achieved.

The headpiece 20 therefore comprises every means which, together with the valve 40, enables the cylinder-piston unit to be operated. It is necessary merely to connect the inlet 23 to a feed pipe for the pressurized operating fluid and connect the pilot valve 40 to an electrical supply cable.

In a different embodiment (not shown in the figures) the cylinder-piston unit is single-acting, ie it possesses only one operating chamber, for example the chamber 11, which is connected alternately to the feed and discharge via the headpiece 20. In this case, compared with the embodiment illustrated in the figures, the headpiece 20 possesses only the first conduit 21, plus the inlet 23 and discharge 24. It also possesses only the first passage A and the second passage B, together with a single cover 27d. The first pilot duct 51 hence communicates only with the chamber 35a, and the second pilot duct 52 communicates only with the chamber 35d of the second passage B. The pilot valve 40 remains unmodified.

On setting the valve 40 into its first configuration, the first duct 51 is connected to the discharge outlet 44, whereas the second duct 52 is connected to the inlet 23.

Consequently, the lateral chamber 35a of the first passage A is put to discharge with the result that the respective membrane 36 leaves the passage for the operating fluid free. Simultaneously, the lateral chamber 35b of the second passage B is put under pressure, the respective membrane 36 consequently being pressed against the ports 31 and 32 to close passage for the operating fluid.

Hence the operating fluid passes from the inlet 23 to the first conduit 21 and from there to the first operating chamber 11 of the cylinder-piston unit.

In the second configuration of the valve 40, the first duct 51 is connected to the inlet 23, whereas the second duct 52 is connected to the discharge outlet 44.

Consequently, the lateral chamber 35a of the first passage A is put under pressure, the respective membrane 36 consequently being pressed against the ports 31 and 32 to close the passage for the operating fluid. Simultaneously, the lateral chamber 35b of the second passage B is put to discharge with the result that the respective membrane 36 leaves the passage for the operating fluid free.

It follows that the first chamber 11 of the cylinder-piston unit is connected to discharge 24 via the first conduit 21 and via the second passage B.

Numerous modifications of a practical and applicational nature can be made to the invention concerned, but without leaving the scope of the inventive idea as claimed below.

1. A fluid operated cylinder-piston unit having at least a first operating chamber for alternate connection to a pressurized fluid feed and to a discharge, and having at least one headpiece (20) to which the cylindrical wall (10) laterally bounding the operating chamber is connected, characterised by comprising:
a pressurized fluid inlet (23) to be connected to the feed, and provided within the body (25) of the headpiece;
a fluid outlet (24) provided within the body (25) of the headpiece;
at least one conduit (21) provided within the body (25) of the headpiece and communicating with the first operating chamber;
within the body (25) of the headpiece, between the inlet (23) and the conduit (21), a first passage (A) having in a lateral face of the body (25) of the headpiece two spaced-apart ports (31a, 32a), one communicating with the inlet (23) and the other with the conduit (21);
within the body (25) of the headpiece, between the outlet (24) and the conduit (21), a second passage (B) having in a lateral face of the body of the headpiece two spaced-apart ports (31b, 32b), one communicating with the outlet (24) and the other with the conduit (21);
in each of said passages (A, B) there being provided a valve for opening or closing the fluid passage, comprising a lateral chamber (35) covering said communication ports (31, 32) and formed in a cover (27d, 27s) positioned on the lateral face of the body of the headpiece, and a free flexible membrane (36) separating said ports (31, 32) from the lateral chamber (35) and being of such an area as to cover said communication ports (31, 32), it being arranged to assume a first position in which it adheres to the edge of the ports (31, 32) and a second position in which it is raised from the edge of the ports (31, 32);
pilot means able to feed into each lateral chamber (35) a pilot fluid having a pressure such as to urge the membrane (36) into the first position and to press on it with a thrust sufficient to prevent passage of fluid through the ports (31, 32), against the thrust of the fluid present in the ports.

2. A cylinder-piston unit as claimed in claim 1, characterised by that said pilot means comprise thin pilot channels (51, 52) provided partly within the body (25) of the headpiece and partly in the cover (27d, 27s), which communicate with each lateral chamber (35), and a pilot valve means (40) communicating with the fluid feed, to distribute, when commanded, pressurized pilot fluid to the lateral chambers (35) via said pilot channels (51, 52), to open the first passage (A) and close the second (B) and vice versa.

3. A cylinder-piston unit as claimed in claim 1, also having a second operating chamber (12) opposing the first (11 ), characterised by comprising:
a second conduit (22) provided within the body (25) of the headpiece and communicating with the second operating chamber (12),
within the body (25) of the headpiece, between the inlet (23) and the second conduit (22), a third passage (C) having in a lateral face (265) of the body (25) of the headpiece two spaced-apart ports (31c, 32c), one communicating with the inlet (23) and the other with the second conduit (22);
within the body (25) of the headpiece, between the outlet (24) and the second conduit (22), a fourth passage (D) having in a lateral face (26s) of the body (25) of the headpiece two spaced-apart ports (31d, 32d), one communicating with the outlet (24) and the other with the second conduit (22);
in each of said passages there being provided a lateral chamber (35) covering said communication ports (31,32) and formed in a cover (27d, 27s) positioned on the lateral face (26d, 26s) of the body of the headpiece, and a free flexible membrane (36) separating said ports (31, 32) from the lateral chamber (35) and being of such an area as to cover said communication ports (31, 32), it being arranged to assume a first position in which it in contact with the edge of the ports (31,32) and a second position in which it is raised from the edge of the ports (31, 32);
the pilot valve means (40) being arranged to distribute the pressurized pilot fluid to the lateral chambers (35) in such a manner as to achieve a first configuration in which the first passage (A) and the fourth passage (D) are open whereas the second passage (B) and the third passage (C) are closed, and a second configuration in which the second passage (8) and the third passage (C) are open whereas the first passage (A) and the fourth passage (D) are closed.

4. A cylinder-piston unit as claimed in claim 3, characterised in that:
the first conduit (21) and the second conduit (22) are positioned with their axes longitudinal and are mutually superposed;
the inlet (23) comprises a cavity (231) of longitudinal axis positioned below said conduits (21, 22);
the first passage (A) and the second passage (B) are both positioned on one lateral face (26d) of the body (25) of the head, the third passage (C) and the fourth passage (D) being both positioned on the other lateral face (26s) of the body (25) of the head.

5. A cylinder piston unit as claimed in claim 3, characterised in that the cylindrical wall (10) laterally bounding the operating chambers (11, 12) comprises a longitudinal channel (222) extending longitudinally within the thickness of the wall and connected at one end to the second conduit (22), its other end opening into the second operating chamber (12).

6. A cylinder-piston unit as claimed in claim 3, characterised in that within the body (25) of the headpiece and within the covers (27s, and 27d) there is provided a system of thin channels through which the pilot fluid flows, and which comprises:
a first duct (51) extending from a port (51′) and leading both to the lateral chamber (35a) of the first passage (A) and to the lateral chamber (35d) of the fourth passage (D);
and a second duct (52) extending from a second port (52′) and leading both to the lateral chamber (35b) of the second passage (B) and to the lateral chamber (35c) of the third passage (C);
said ports (51′ and 52′) being both provided in the face (26′) of the body (25) and being connected to the pilot valve (40).
